(19) United States
(12) Patent Application Publication
(10) Pub. No.: US 2019/0150485 A1
(43) Pub. Date: May 23, 2019

(54) PROCESS FOR THE PREPARATION OF A FOOD AND KITS FOR THE PREPARATION OF SAID FOOD BY SAID PROCESS

(71) Applicant: Emanuela COMPARINI, Roma (IT)

(72) Inventor: Emanuela COMPARINI, Roma (IT)

(21) Appl. No.: 16/081,954

(22) PCT Filed: Feb. 17, 2017
(86) PCT No.: PCT/IT2017/000030

§ 371 Date: Sep. 4, 2018

(30) Foreign Application Priority Data
Mar. 25, 2016 (IT) 102016000031277

(51) Int. Cl. A23L 5/10; A23L 7/109; A23L 3/3418; A23L 3/10; A23L 3/36; A23L 23/00; B65D 81/34

(52) U.S. Cl. CPC A23L 5/15; A23L 7/109; A23L 3/3418; A23V 2002/00; A23L 3/36; A23L 23/00; B65D 81/3446; A23L 3/10

(57) ABSTRACT

The present invention relates to a process for the preparation of a food from a kit comprising a first sealed bag or container containing a dry product, and a second sealed bag or container, containing a sauce, said sauce providing a seasoning portion and a wet portion, in addition to the seasoning humidity, the ratio between the seasoning portion and the wet portion of said sauce varying between 10% by weight and 60% by weight of the seasoning portion and between 40% by weight and 90% in weight of the wet portion, said second bag and its contents, being subjected to sterilization or to pasteurization, in this case with the pH content less than 4.2, the process comprising the following steps:

a. opening the first bag containing the dry product, and placing the contents into a heatable container by a heat source;

b. opening the second bag containing the sauce and covering the dry product placed in the earlier stage a. in the heatable container;

c. activating the heat source, heating the container containing the dry product and the sauce for a period of time sufficient to allow that the whole is cooked.

The invention further relates to a kit for the preparation of a food by said process.

The present invention relates to a process for the preparation of a food and to a kit for the preparation of said food by said process.

In recent years there has been a considerable spread of the use of meals ready-to-use in order to avoid the long preparation time for the preparation of the additional seasoning and for cooking the same plate.

Particularly there is a wide range of frozen main courses, but which need to be preserved within a freezer.

This is due to the fact that it is always increasing the need to consume quality products, preferably not at home, being able to devote little time to the different phases of preparation and cooking of the food to be eaten.

The products available on the market are stocked within envelopes that do not make it possible an easy cooking of the same, requiring at least a container or a kitchen tool, such as a frying pan, according to the necessary cooking.

To solve this problem, there have been thought, and there are available on the market, many frozen products (such as “Pasta Cup Barilla®”) and/or sterilized and/or chilled in resealable convenient packages of ready-to use flour based products such as pasta, rice and other, stored within a freezer at -18° C., with a duration of 12/18 months, refrigerated at +4 to +8° C. and stored in a refrigerator for 6-8 months or stored sterilized in the shelf and with a 36 months shelf life. The operations required for the preparation of the above product are:
introducing the package in the microwave for the time indicated;
opening the container (which maintains the ideal temperature up to about twenty minutes), mixing and serving the product.

However, products of this type must be stored within the freezer and, in the case of pasta and similar products already cooked, it is not possible controlling the pasta cooking time.

The same problem due to the impossibility of controlling the cooking time and to the conservation is present with pre-cooked dishes to be heated or cooked, which, however, should be stored within a refrigerator, generally at 0-4° C., and thus have a limited shelf life.

In view of the above, it appears evident the need to have available a system which overcomes the drawbacks of the known products available on the market.

In this context it is included the solution according to the present invention, aiming to provide a process for the preparation of a food, and the relative kit including a flour based or not product, and a sauce, which can be stored without requiring special precautions at room temperature and which can be used simply by having a heat source, such as microwave oven and/or a convection, gas or electric, oven, ventilated or not and/or a simple fire.

The process according to the invention can be implemented simply by placing the flour based or not product in a container and subsequently covering said product with the suitably prepared sauce, and then subjecting it to a heat source.

It is therefore specific object of the present invention a process for the preparation of a food from a kit comprising a first sealed bag or container containing a dry product, and a second sealed bag or container, containing a sauce, said sauce providing a seasoning portion and a wet portion, in addition to the seasoning humidity, the ratio between the seasoning portion and the wet portion of said sauce varying between 10% by weight and 60% by weight of the seasoning portion and between 40% by weight and 90% in weight of the wet portion, said second bag and its contents, being subjected to sterilization or to pasteurization, in this case with the pH content less than 4.2, the process comprising the following steps:

a. opening the first bag containing the dry product, and placing the contents into a heatable container by a heat source;

b. opening the second bag containing the sauce and covering the dry product placed in the earlier stage a. in the heatable container;

c. activating the heat source, heating the container containing the dry product and the sauce for a period of time sufficient to allow that the whole is cooked.

Preferably, according to the invention, said heat source can be a microwave oven, a gas, electrical, or induction cooking machine, a fire, etc.

Furthermore, according to the invention, said container can be a container suitable for microwave oven, optionally with a lid, a frying pan or a pot, etc.

Still, according to the invention, said second bag can be comprised of a bag made up gas and the light impermeable material.

Further, according to the invention, there can be provided one or more additional bags or containers containing dry seasonings not included in the sauce.

Always, according to the invention, said sauce can be inserted in said second bag at a temperature above about 50° C.

Furthermore, according to the invention, said sauce can be inserted in said second bag at a temperature below about 50° C., and it is subjected to nitrogen blowing.

The invention further relates to a kit for the preparation of a food by a process as described in the above, said kit comprising a first sealed bag or container containing a dry product, and a second sealed bag or container, containing a sauce, said sauce providing a seasoning portion and a wet portion, in addition to the seasoning humidity, the ratio between the seasoning portion and the wet portion of said sauce varying between 10% by weight and 60% by weight of seasoning portion, and between 40% weight and 90% by weight of the wet portion, said second bag and its contents being subjected to sterilization or pasteurization, in this case with pH of less than 4.2 content.

Still, according to the invention, said kit can provide a container suitable for microwave oven, preferably with a lid.

Always, according to the invention, said second bag can be is comprised of a bag made up gas and the light impermeable material.

Finally, according to the invention, there can be provided one or more additional bags or containers containing dry seasonings not included in the sauce.

The solution according to the present invention allows obtaining a kit for the preparation of a food that contains all the components necessary for the preparation, cooking and containment of the same food, and that after consuming the meal can be directly thrown away.

The food prepared by the process according to the invention makes it possible to satisfy the needs of the users who, while changing eating habits in favour of meals convenient and quick to consume, do not want to give up either to the taste and the characteristic flavour of fresh products or standards safety and nutritional quality of the food.

Being a kit which keeps separate the flour based or not product, from the solution containing the seasoning, the preparation of the food maintains that “charm” linked to the dexterity in the kitchen and the satisfaction by the user to be able to eat a food cooked “with their own hands”, while greatly reducing the periods involved in the preparation. This aspect is also advantageously related to the fact that it allows to obtain the desired degree of cooking of pasta, for example a cooking “al dente”, since the solution in addition to seasoning already contains the amount of water required for cooking the flour based or not product.

By the present invention, the user is also sure that the amount of seasoning contained in the kit is suitable for seasoning the amount of pasta present in the same kit.

A further advantage is due to the fact that the kit according to the present invention, although stored at room temperature, has a prolonged shelf life of the edible component and therefore does not need to be stored within the refrigerator or freezer. For this reason, the kit also has the possibility of being brought by the user without any concern about its conservation.

The solution according to the present invention enables to provide a kit for fast cooking the product contained in the same kit.

The excess moisture, obviously calibrated in function of the type of cooking for which the product is intended, can be constituted by water, broth, or other suitable liquid.

Additionally, the kit can be prepared for a single serving, or for portions for a plurality of persons.

The present invention has been described for illustrative but not !imitative purposes, according to its preferred embodiments, but it is to be understood that variations and/or modifications can be introduced by those skilled in the art without departing from its scope, as defined by the enclosed claims.

1. Process for the preparation of a food from a kit comprising a first sealed bag or container containing a dry product, and a second sealed bag or container, containing a sauce, said sauce providing a seasoning portion and a wet portion, in addition to the seasoning humidity, the ratio between the seasoning portion and the wet portion of said sauce varying between 10% by weight and 60% by weight of the seasoning portion and between 40% by weight and 90% in weight of the wet portion, said second bag and its contents, being subjected to sterilization or to pasteurization, in this case with the pH content less than 4.2, the process comprising the following steps:
a. opening the first bag containing the dry product, and placing the contents into a heatable container by a heat source;
b. opening the second bag containing the sauce and covering the dry product placed in the earlier stage a. in the heatable container;
c. activating the heat source, heating the container containing the dry product and the sauce for a period of time sufficient to allow that the whole is cooked.

2. Process according to claim 1, characterized in that said heat source is a microwave oven, a gas, electrical, or induction cooking machine, a fire, etc.

3. Process according to claim 1, characterized in that said container is a container suitable for microwave oven, optionally with a lid, a frying pan or a pot, etc.

4. Process according to claim 1, characterized in that said second bag is comprised of a bag made up gas and the light impermeable material.

5. Process according to claim 1, characterized in that there are provided one or more additional bags or containers containing dry seasonings not included in the sauce.

6. Process according to claim 1, characterized in that said sauce is inserted in said second bag at a temperature above about 50° C.

7. Process according to claim 1, characterized in that said sauce is inserted in said second bag at a temperature below about 50° C., and it is subjected to nitrogen blowing.

8. Kit for the preparation of a food by a process according to claim 1, said kit comprising a first sealed bag or container containing a dry product, and a second sealed bag or container, containing a sauce, said sauce providing a seasoning portion and a wet portion, in addition to the seasoning humidity, the ratio between the seasoning portion and the wet portion of said sauce varying between 10% by weight and 60% by weight of seasoning portion, and between 40% weight and 90% by weight of the wet portion, said second bag and its contents being subjected to sterilization or pasteurization, in this case with pH of less than 4.2 content.

9. Kit according to claim 8, characterized in that said kit includes a container suitable for microwave oven, preferably with a lid.

10. Kit according to claim 8, characterized in that said second bag is comprised of a bag made up gas and the light impermeable material.

11. Kit according to claim 8, characterized in that there are provided one or more additional bags or containers containing dry seasonings not included in the sauce.
